(19) United States
(12) Patent Application Publication
(10) Pub. No.: US 2026/0322599 A1
(43) Pub. Date: Oct. 15, 2026

(54) METHODS FOR ANONYMOUS COMMUNICATION IN A RING TOPOLOGY NETWORK

(71) Applicant: Airbus SAS, BLAGNAC (FR)

(72) Inventor: Markus KLÜGEL, BLAGNAC (FR)

(21) Appl. No.: 19/463,292

(22) Filed: Jan. 29, 2026

(30) Foreign Application Priority Data
Jan. 31, 2025 (DE) 102025000399.4

(51) Int. Cl. H04L 9/08; H04L 12/46

(52) U.S. Cl. CPC H04L 9/088; H04L 9/0891; H04L 12/4637

(57) ABSTRACT

Methods for anonymized communication in a network having nodes arranged in a ring topology are disclosed. The methods are based on a communication protocol and secure the anonymity of the sender and receiver in a closed group network by using temporary keys that may be randomly generated and sending encrypted information to successor nodes. Also communication systems with nodes configured for the methods.

### CROSS-REFERENCE TO RELATED APPLICATIONS

This application claims priority to German Patent Application No. DE 10 2025 000 399.4, filed on Jan. 31, 2025, the entire disclosure of which is incorporated herein by way of reference.

### FIELD OF THE INVENTION

The invention relates to methods for anonymized communication in a network, the nodes of which are arranged in a ring topology. The methods are based on the “Dining Cryptographers” protocol, a communication protocol that secures the anonymity of the sender and receiver in a closed group network. A communication system having a network of network nodes that are actively communicatively connected in a ring topology can implement these methods.

### BACKGROUND OF THE INVENTION

The document Chaum, David: “The Dining Cryptographers Problem: Unconditional Sender and Recipient Untraceability”, Journal of Cryptology 1(1):65-75, 1988 discloses in an illustrative example scenario the application of a communication protocol to securing the anonymity of the sender and receiver in a group of mutually known network participants communicating with one another. The network participants agree in pairs on a symmetric communication key that is secret to all other network participants. One of the pair of network participants uses the symmetric communication key, while the other of the pair of network participants uses the inverse symmetric communication key.

Each network participant now encrypts a message known only to him sequentially with the negotiated communication keys or their inverses assigned to that participant. The messages encrypted in this way are communicated to all network participants via an appropriate distribution protocol. All encrypted messages can then be logically summed-if the messages as well as the symmetric communication keys are part of a finite Abelian group, all symmetric communication keys with the necessarily existing inverses will cancel out again in the logical summation, so that the logical summation of all messages is again in plain text form, without it being possible to draw a conclusion as to which part of the logical summation of all messages originates from which network participant.

The method proposed by Chaum is known as the “Dining Cryptographers” protocol (DCP) and is information-theoretically secure. Due to the bandwidth requirements, however, it is only suitable to a limited extent for large groups of network participants or for high message lengths, since all network participants must send data with the length of the longest messages to be sent, regardless of the length of their own message. In addition, network participants must send the encrypted messages to all other network participants in order to be able to communicate the messages. As a result, the bandwidth requirement for N network nodes is of the order of O(N²) per communication round.

Various attempts have since been made to make the use of the DCP more manageable, secure and scalable. An overview of most of these previous attempts is given in Shirali, Mohsen; Tefke, Tobias; Staudemeyer, Ralf; Pöhls, Henrich: “A Survey on Anonymous Communication Systems With a Focus on Dining Cryptographers Networks”, IEEE Access. Vol. 11, pages 18631-18659, 2023.

In addition, the publication LU 92356 B1 discloses an extended dining cryptographer protocol that enables reliable collision resolution using a collision resolution algorithm. The paper by Sardroud, Asghar A. Asgharian, Mohammad Sadeq Dousti and Rasool Jalili: “An Efficient DC-Net Based Anonymous Message Transmission Protocol”, in 6th Int. ISC Conf. on Information Security and Cryptology (ISCISC'09), 2009, discloses a DC network protocol that enables n simultaneous anonymous communication channels with the same message complexity as the original DC network protocol while reducing the bit complexity by an order of magnitude O(n). The paper by Bauer, Johannes, and Ralf C. Staudemeyer: “From Dining Cryptographers to dining things: Unobservable Communication in the IoT”, 2017 IEEE 22^{nd} International Workshop on Computer Aided Modeling and Design of Communication Links and Networks (CAMAD), June 2017, pp. 1-7 discloses extensions of the DCP to networks on the Internet of Things.

Nevertheless, in a ring topology, the DCP provides a valuable concept for anonymous network communication between known network participants. It uses pairwise shared secrets and group operations of a finite Abelian group to conceal the source of the message while it travels within the ring. The key negotiation protocol defines these secrets, and a slot reservation protocol can be used to ensure that only one message is on the network at a time. The basic principle of anonymity is that only the originator of the message needs to make a change to the message and all other nodes in the network forward the message by group operations with the keys assigned to them.

### SUMMARY OF THE INVENTION

One of the objects of the invention is therefore to find solutions for the more efficient use of the “Dining Cryptographers” protocol (DCP). In particular, it is desirable to significantly reduce the data throughput required for implementing the DCP when exchanging messages between network participants in a network with ring topology.

These and other objects may be achieved by the subject matter having the features of one or more of the embodiments described herein.

According to a first aspect of the invention, a computer-implemented method for anonymized communication in a network with ring topology comprises the steps of: receiving, by an active network node of a plurality of network nodes, a message array which has a plurality of disjoint message windows, each uniquely assigned to one of the plurality of network nodes, from a predecessor node in the ring topology, wherein the message windows contain encrypted messages to the respective assigned network node as a group operation combination chain of keys and message contents belonging to a finite Abelian group; obtaining, by the active network node, a temporary key assigned to the predecessor node; decrypting a message directed to the active network node by combining the message array with the inverse element of the temporary key assigned to the predecessor node and with its own temporary key stored in a local key memory via the group operation of the finite Abelian group; resetting, by the active network node, the decrypted message content in the assigned message window to the null element of the finite Abelian group; creating a new temporary key and overwriting the local key store with the new temporary key; encrypting, by the active network node, the message array with the reset message window by combining the message array with the new temporary key via the group operation of the finite Abelian group; and sending, by the active network node, the encrypted message array to a successor node in the ring topology.

According to a second aspect of the invention, a computer-implemented method for anonymized communication in a network with ring topology comprises the steps of: receiving, by an active network node of a plurality of network nodes, a message array which has a plurality of disjoint message windows, each uniquely assigned to one of the plurality of network nodes, from a predecessor node in the ring topology, wherein the message windows contain encrypted messages to the respective assigned network node as a group operation combination chain of keys and message contents belonging to a finite Abelian group; obtaining, by the active network node, a temporary key randomly selected by the predecessor node; randomly selecting, by the active network node, a temporary key and overwriting a local key memory with the randomly selected temporary key; adding, by the active network node, a message content directed to another of the network nodes by combining the encrypted content of the message window assigned to the other of the network nodes via the group operation of the finite Abelian group; encrypting, by the active network node, the message array by combining the message array with the randomly selected temporary key via the group operation of the finite Abelian group; and sending, by the active network node, the encrypted message array and the randomly selected temporary key to a successor node in the ring topology.

According to a third aspect of the invention, a communication system comprises a plurality of network nodes that are actively communicatively connected in a ring topology. The network nodes are collectively designed to carry out one or both of the methods according to one of the first and second aspects of the invention.

An essential idea of the invention is that of modifying messages of the DCP in a ring topology network in such a way that each network participant sees in plain text only that portion of the messages that are addressed to him, without it being possible to conclude from this message who originally sent the message. This can be achieved by the fact that message components that are not intended to be seen in plain text are always encrypted by two key operations, where each network participant is able to reverse only one of these key operations using a key known to him. The portion of the messages that are actually addressed to the network participant in this communication round can only be decrypted once by the network participant, since the predecessor node selects the last key afresh and appends it to the message. After the decryption of the messages addressed to the currently receiving network participant in the decryptable part, this network participant can reset the decrypted part to zero, so that subsequent network participants in the ring from previous communication rounds can no longer draw conclusions about the content and sender of this message part.

Another essential idea of the invention is to dispense with a two-sided key negotiation protocol between adjacent network nodes and instead to allow the predecessor node in the ring topology to unilaterally select a new temporary key at random. This is particularly advantageous if a trust relationship can be or has been established between the network nodes in another way. In closed network environments that require external certification to participate in network data traffic, this measure can significantly reduce the number of key negotiation messages to be exchanged and greatly accelerate message exchange.

Advantageous embodiments and extensions are obtained from the description, with reference to the figures.

According to some embodiments of the method according to the first aspect of the invention, the creation of the new temporary key may involve a random selection by the active network node of an element of the finite Abelian group as the new temporary key.

According to some further embodiments of the method according to the first aspect of the invention, the method may further comprise the step of sending, by the active network node, the new randomly selected temporary key to the successor node in the ring topology.

In some of these embodiments of the method according to the first aspect of the invention, the transmission of the randomly selected new temporary key can take place via a secured communication channel outside the network.

According to some further embodiments of the method according to the first aspect of the invention, the active network node, before encrypting the message array, can combine a message content directed to another of the network nodes with the encrypted content of the message window assigned to the other of the network nodes via the group operation of the finite Abelian group.

According to some embodiments of the method according to the second aspect of the invention, all method steps can be iterated until the message array has completely traversed the ring topology once.

According to some further embodiments of the method according to the second aspect of the invention, the method may further comprise the step of broadcasting the encrypted message array to all network nodes, after all iterations of the method steps have been carried out.

In some of these embodiments of the method according to the second aspect of the invention, the method may further comprise the step of decrypting the messages directed to the respective network node by combining the message array with its own temporary key stored in the local key memory via the group operation of the finite Abelian group.

Where practical, the above embodiments and extensions can be combined with each other in any way desired. Further potential embodiments, extensions and implementations of the invention also comprise combinations of features of the invention either described previously or in the following in relation to the exemplary embodiments, which are not explicitly mentioned. In particular, the person skilled in the art will also be able to add individual aspects as improvements or additions to each basic form of the present invention.

### BRIEF DESCRIPTION OF THE CONTENT OF THE DRAWINGS

The present invention is described in more detail below with the aid of the exemplary embodiments specified in the schematic drawings. In the drawings:

FIG. 1 shows a schematic block diagram of a communication system in accordance with one embodiment of the invention;

FIG. 2 shows a flowchart of a computer-implemented method for anonymized communication in a network with ring topology according to a further embodiment of the invention; and

FIG. 3 shows a flowchart of a further computer-implemented method for anonymized communication in a network with ring topology according to a further embodiment of the invention.

The enclosed figures are intended to convey a further understanding of the embodiments of the invention. They illustrate embodiments and are used in connection with the description to provide an explanation of principles and concepts of the invention. Other embodiments and many of the advantages cited are obtained by reference to the drawings. The elements of the drawings are not necessarily shown true to scale. Directional terminology such as “top”, “bottom”, “left”, “right”, “above”, “below”, “horizontal”, “vertical”, “front”, “rear” and similar terms are used for explanatory purposes only and are not intended to limit the generality to specific embodiments as shown in the figures.

In the figures of the drawing, identical, functionally equivalent and identically acting elements, features and components are each labelled with the same reference numeral, unless stated otherwise.

### DESCRIPTION OF EXEMPLARY EMBODIMENTS

The origin of the word anonymity can be traced back to the Greek language—in the context of a set of nodes in a network configuration which exchange data via communication links, a communication protocol is deemed to ensure the anonymity of a network node if and only if all other network nodes or external third parties are not able to determine whether and which message the network node to remain anonymous has sent in the network. This also applies to the network nodes to which the network node to remain anonymous addressed the message. Information about the sender and recipient of messages in networks is metadata, knowledge of which is already sufficient to derive important and potentially confidential information about the type of messages exchanged or the role distribution of participants in a network configuration. Knowledge of such metadata can have unpleasant consequences, according to a statement by former NSA and CIA director Michael Hayden: “We kill people based on metadata.”

There are various, more or less practicable, approaches to ensuring anonymity. One approach, for example, is to shield the transmission of messages as such; however, this approach is not only physically difficult to implement, but above all is not helpful when network participants are generally known to each other. The same applies to the disguised sending of meaningless empty messages (so-called “dummy” messages), which keep a message exchange secret from uninvolved network participants, but do not do so from the actual recipient of a meaningful message. This problem must be addressed by ensuring that a recipient of a communication addressed to him cannot infer the content of messages from other participants, in particular the sender, from the communication containing the message.

The “Dining Cryptographers” (DCP) problem, originally conceived by David Chaum, aims to allow anonymous communication among a group of participants known to each other. The striking example chosen by Chaum, which gives the problem its name, involves a group of cryptography experts who are sitting at a restaurant table and have just had dinner together. One of them has paid for the food, and while it is of interest to everyone that someone from the group paid for the meal, the identity of the payer should remain secret. A general announcement that someone has paid does not protect the anonymity of the payer, since only the payer has the sure knowledge of having paid.

A solution to the DCP (DCP protocol) conceived of by Chaum allows anonymous messages to be exchanged among the cryptography experts, with appropriate encryption, without generally disclosing the sender of this message. This solution is based on a network with ring topology. In a ring topology, each participant (cryptography expert) is connected to exactly two others, so that (at least one) closed network loop is formed. This is a common network structure used to illustrate DCP. Without limitation of generality, N network participants exist which can be uniquely identified by means of sequential numbering i∈{1, . . . , N}.

Each network participant shares a common secret with his immediate neighbor in the ring, which is known only to these two participants, so that each network participant has two unique secret keys at all times, which allow the communication to be encrypted. Again, without limitation of generality, these keys are referred to as K_{i,j}, where i and j are the identification numbers of neighboring network participants. The key K_{i,j} is therefore only known to the network participants i and j. Due to the ring topology, the network participants i=N and j=1 are adjacent, so that one of the keys is K_{N,1}.

The keys are a subset of a finite Abelian group (F, ⊕) and messages are combined with the key via the group operation ⊕. This is a generalization of the concept of Chaumian anonymization by message superposition. The messages are also selected as an element of the group (F, ⊕), with the neutral element of the group acting as a dummy message. The individual messages are exchanged among the network participants in a round-robin process, wherein each network participant decrypts the messages received from one of his neighbors with the respective key −K_{i-1,i}, adds his own message, and encrypts the resulting message with the respective K_{i,i+1}. The combination of pairwise encryption and decryption by each key K_{i,j} used creates a cancelling effect overall, so that a combination of all individual messages via the group operation ⊕ results in a globally unencrypted message. All dummy messages and keys disappear, so that only actual messages are visible to all participants, without the possibility of assigning these messages to a specific network participant. This procedure therefore allows the anonymity of the senders of the actual messages to be protected.

For key generation, cryptographically strong and randomly generated keys are negotiated between adjacent network participants. One way to do this is the Diffie-Hellman key exchange. However, other suitable key negotiation protocols can also be used, such as the ElGamal protocol or the Rabin protocol.

To avoid message collisions and to increase the efficiency and resilience of the message exchange, a suitable slot reservation protocol can be used. Such a slot reservation protocol prevents two network participants from trying to forward messages simultaneously, i.e., in the same message exchange round. A slot in this case is a predefined time window within which a message can be validly sent. Network participants send their messages cyclically in the next available time window. Of course, if no message needs to be sent, network participants can send dummy messages or null messages.

In one possible slot reservation protocol, the network participant i sends a reservation request for the time window t to send a message M to the network participant i+1. Network participant i+1 then checks whether the time window t is still available for a reservation. If this is the case, he sends a confirmation message back to the network participant i for reservation confirmation. Otherwise, network participant i is informed of the non-availability and network participant i must request a different time window t'. In the case of a reservation confirmation for the time window t, network participant i writes and transmits his anonymized message using the reserved time window t.

The main advantages of the DCP protocol are anonymity, simplicity and decentralization. No participant can determine the sender of the message, which means that the privacy of all network participants is preserved. However, the protocol is also relatively easy to understand and implement. In addition, no central authority is required, because after agreement on the protocol, the network participants can manage the communication themselves.

Possible drawbacks of the DCP protocol are its poor scalability, fragile network reliability, reduced practicability, and vulnerability to collusion by bad-faith network participants.

For example, if a sufficient number of network participants collaborate in secret and, for example, compromise the mutual confidentiality of the keys, other network participants can be de-anonymized. In addition, if a single network node of the ring topology fails, then the entire network can fail. In networks where the trustworthiness and reliability of the network participants is already given as such or can be ensured by other measures, these problems are less important.

However, the DCP requires a significant amount of data for anonymized and secure communication, which scales at an unfavorable rate with the number of participants N. In principle, every participant must exchange messages with every other participant, resulting in a communication complexity of the order of magnitude O(N²). Furthermore, while the cryptographic operations for key negotiation are generally not complex, the need for pairwise communication increases the computational load polynomially with the number N of network participants, potentially resulting in a bottleneck in environments with inherent resource scarcity, such as an IoT environment. In addition, in the DCP it is necessary that all network participants act in a synchronized manner. Any delay or asynchrony can shut down the entire communication process, impairing the reliability and efficiency of the protocol.

In order to reduce the communication effort and reduce the number of steps required for data exchange, the following text describes modifications to the DCP in which network participants can perform key replacement operations in successive rounds of communication, in which the replacement key is only communicated once to the subsequent network participant in the ring network and in a volatile manner (“ephemerally”) in relation to subsequent communication rounds, so that the additional communication steps for the key negotiation and the general transmission of all individual messages to all network participants conventionally required after a communication round can be omitted. These modifications can reduce the amount of data required to implement the communication protocol to roughly half the amount required for the classical DCP.

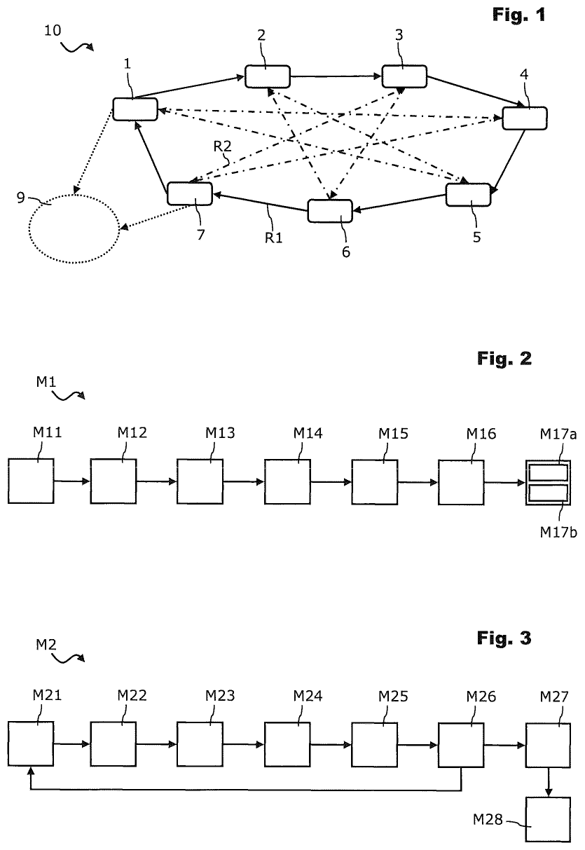

FIG. 1 shows an exemplary schematic representation of a communication system 10 having a number of network nodes arranged in a ring topology. As an example without limitation of generality, seven network nodes 1, 2, 3, 4, 5, 6 and 7 are shown, but the communication system 10 may have any other number of network nodes. The network nodes 1 to 7 represent logical units of network participants, each of which may have similar or different electronic communication devices, such as computers, wireless communication devices, mobile phones, smartphones, laptops, control devices of Internet-of-things (IoT) devices, vehicle control units, machine controllers, drones, robots or the like. The network nodes 1 to 7 are each actively connected via communication channels for digital or analogue data exchange, for example via wired, wireless, radio-based, data-optical, satellite-based or other communications links. The network nodes 1 to 7 can also be a logical part of a higher-level additional network 9, such as the Internet.

By way of example the network nodes 1 to 7 are—without limitation of generality—in active communicative connection with each other in a ring topology R1. Other ring topologies, such as the ring topology designated as R2, are also possible as an alternative or in addition to the ring topology R1. For the sake of simplicity, the following assumes that for a number N of network nodes, each network node n∈{0, . . . , N−1} has a predecessor node (n−1) mod N and a successor node (n+1) mod N. However, the numbering of the network nodes is chosen solely for illustrative purposes.

FIGS. 2 and 3 each show a flow diagram of computer-implemented methods M1 and M2 for anonymized communication in a network with ring topology, such as in a network of the communication system 10 explained in connection with FIG. 1. The methods M1 and M2 can begin with the initiation of a message cycle through the network nodes of the ring of the communication system, by one of the network nodes—without limiting the generality of the network nodes n₁—generating an empty message C₁. This empty message C₁ may contain, for example, a matrix or an array of size N*N*B, where N represents the number of network nodes interconnected in ring topology and B represents the number of bits of the messages to be sent. The message array is divided into N² disjoint message windows (“slots”), which each represent all bilateral send and receive relationships of all N network nodes, i.e., each of the disjoint message windows is biuniquely assigned to one of the network nodes as a receiving zone for messages from other network nodes.

The messages themselves and the keys for encrypting them are a subset of a finite Abelian group (F, ⊕) and arbitrary messages and keys can be combined using the group operation ⊕. A special case of a finite Abelian group (F, ⊕) is a Galois field GF(2)^{B} of bit width B with the exclusive OR logic operation (XOR) as the group operation ⊕. As alternative finite Abelian groups, for example, finite Galois fields in general or prime fields Z/pZ (residual equivalence classes of the whole numbers modulo p, with p a prime number) can be selected. Such fields allow the generation of keys via a primo known start values (“seeds”) of a pseudo-random number generator. In the following, therefore, instead of keys per se, such starting values can also be forwarded or exchanged, as these allow a bijective mapping onto keys.

To determine which message window is assigned to which network node to receive messages intended for it, a slot reservation protocol must be implemented that ensures that, while each network node knows when to send, it cannot ascertain which network node is sending in the other message windows.

There are generally three different approaches to this: “reservation mapping”, which uses “scheduling vectors” for upcoming communication rounds, the vector elements of which are slot indices which can mark the network nodes as “occupied” (for example, Herbivore); collision resolution methods (for example, Slotted ALOHA); and secured multi-party computations (MPC), in which the calculation is based on the secret disclosure of all inputs and on zero knowledge proofs (ZKP) for assigning message windows (for example, Verdict or SICTA).

The initiating network node n₁ then generates an initial temporary key X₁₂, which is stored locally in the network node n₁. The temporary key X₁₂ is used to encrypt messages that are passed from the network node n₁ to the following network node n₂. The network node n₁ then passes both the empty message C₁ and the temporary key X₁₂ to the following network node n₂. The key passing can be carried out as part of the message transmission, provided that the communication channel between the network nodes n₁ and n₂ can be regarded as secure against interception. Otherwise, the network node n₁ can rely on a protected key-sending protocol, for example, using asymmetric cryptographic methods such as RSA, ECC, Diffie-Hellmann or the like, in order to prevent the temporary key X₁₂ or the seed that indexes the temporary key X₁₂ from being intercepted by third parties other than the participating network nodes n₁ and n₂.

Each additional network node nᵢ then repeats these steps in principle by receiving the message array Cᵢ, placing messages to other network nodes nⱼ in the respective message windows as a group operation combination chain of keys X_{i,i+1} belonging to the finite Abelian group (F, ⊕) and message contents Mᵢ and then passing on the message array Cᵢ modified in this way to the successor node in encrypted form.

In this process, two procedures M1 and M2, as illustrated in FIGS. 2 and 3, can be followed—on the one hand, directly upon receipt of a circulating message from the active network node, the node's own message window can be accessed and the messages that may be present there (in the absence of a message, the message content stored there is the null element of the finite Abelian group (F, ⊕)) are decrypted, so that the broadcast step to all network nodes at the end of a communication round as in the conventional DCP can be omitted. On the other hand, it is possible to dispense with a complex key negotiation protocol if, before encrypting the message array Cᵢ to be forwarded, the currently active network node selects a new temporary key itself according to a selection method known to all network nodes and forwards it to the successor node along with the encrypted message array Cᵢ via a secure communication channel.

In the former case, in the method M1, in a step M11 an active network node n can first receive the message array Cᵢ divided into disjoint message windows from a predecessor node nᵢ₋₁ in the ring topology. In parallel, in a step M12 the active network node nᵢ receives a temporary key X_{i-1,i} assigned to the predecessor node. With this key X_{i-1,i} and its own temporary key X_{i,i+1} stored in a local key memory, the active network node nᵢ can generate the intermediate message C′ᵢ=Cᵢ⊕(−X_{i-1,i})⊕X_{i,i+1} in a step M13. This intermediate message C′ᵢ contains all messages to nᵢ in plain text in the message window assigned to the active network node nᵢ, since after a full cycle in the ring topology, all key pairs (−X_{j-1,j})⊕X_{j,j+1} for all j∈{0, . . . , N−1} and j≠i, which are not fully known to the active network node nᵢ, cancel each other out according to the DCP. The encryption of the message window assigned to the active network node nᵢ is now therefore based only on the two keys X_{i-1,i} and X_{i,i+1}, which are known to the active network node nᵢ, however, from the predecessor node nᵢ₋₁ and by its own key selection.

After the active network node nᵢ has decrypted the messages directed to it, in step M14 it can reset the decrypted message content in the assigned message window to the null element of the finite Abelian group (F, ⊕). At the same time, in step M15, the active network node nᵢ creates a new temporary key X′_{i,i+1} and overwrites the local key memory with the new temporary key X′_{i,i+1}. This ensures that other network nodes cannot infer the key used by the active network node nᵢ in further message cycles in the ring topology from knowledge of the encrypted messages from previous message cycles.

The creation of the new temporary key X′_{i,i+1} can be carried out in a conventional manner by carrying out a key negotiation protocol, such as RSA, ECC, Diffie-Hellmann or the like, with the successor node nᵢ₊₁. Alternatively, the active network node nᵢ can also randomly select the new temporary key X′_{i,i+1} as an element of the finite Abelian group.

Using the new temporary key X′_{i,i+1}, in step M16 the active network node nᵢ can encrypt the message array Cᵢ with the reset message window by combining the message array with the new temporary key X′_{i,i+1} via the group operation ⊕ of the finite Abelian group (F, ⊕). Optionally, before encrypting the message array Cᵢ, the active network node nᵢ can combine a message content directed to another of the network nodes nⱼ with the encrypted content of the other message window assigned to the network node nⱼ via the group operation ⊕ of the finite Abelian group (F, ⊕). This setting of the null element as the message content corresponds to omitting communication with the other of the network nodes nⱼ.

The encrypted message array Cᵢ is then passed to the successor node nᵢ₊₁ in the ring topology in step M17a. In the case where a key negotiation protocol is carried out, the new temporary key X′_{i,i+1} does not need to be explicitly communicated to the successor node nᵢ₊₁—but if the active network node nᵢ randomly chooses the new temporary key X′_{i,i+1} itself, the randomly selected new temporary key can be sent to the successor node nᵢ₊₁ in the ring topology in a step M17b, for example together with the encrypted message array Cᵢ in step M17a or via a separate secured communication channel outside the network.

In the second case, in a method M2, in a step M21 an active network node n first likewise receive the message array Cᵢ divided into disjoint message windows from a predecessor node nᵢ₋₁ in the ring topology. At the same time, the active network node nᵢ receives a temporary key X_{i-1,i} randomly selected by the predecessor node nᵢ₋₁ in a step M22. The active network node nᵢ then selects a temporary key X′_{i,i+1} in a step M23 and overwrites a temporary key X_{i,i+1}, which may be stored in a local key memory from a previous communication round, with the randomly selected temporary key X′_{i,i+1}.

In a step M24 the active network node nᵢ then inserts a message content directed to another of the network nodes nⱼ by combining the encrypted content of the message window assigned to the other of the network nodes nⱼ via the group operation ⊕ of the finite Abelian group (F, ⊕). Then, in a step M25, the active network node nᵢ can encrypt the message array Cᵢ with the added message content by combining the message array Cᵢ with the randomly selected temporary key X′_{i,i+1}. This encrypted message array Cᵢ is then sent along with the randomly selected temporary key X′_{i,i+1} to a successor node nᵢ₊₁ in the ring topology.

These method steps can be iterated until the message array has completely traversed the ring topology once. When this is the case, the message array, which has passed through and been sequentially encrypted by each of the network nodes, can be broadcast to all network nodes in a step M27. Each network node is now able to transmit the messages directed to the respective network node in a step M28, by combining the message array with its own temporary key stored in the local key memory via the group operation ⊕ of the finite Abelian group (F, ⊕).

In a possible variant of methods M1 and M2, each network node can initiate a communication round separately and independently of each other. Since only the messages to this network node need to be written to the message array, this message array may contain a matrix or an array of size N*B, where N represents the number of network nodes interconnected in ring topology and B represents the number of bits of the messages to be sent. After a complete pass through the ring topology, the network node initiating the communication round can then decrypt the messages addressed to it in the same manner as in synchronous communication.

In addition, subgroups of network nodes can form their own ring topologies that combine fewer network nodes in a ring than the entire network. As a result, the data requirement decreases further, but in part at the expense of anonymity, since it is already known in advance which network nodes belong to the respective subgroup and are likely candidates for the sender of a message.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

In the previous detailed description, various features have been summarized in one or more examples to improve the consistency of the presentation. However, it should be clear that the above description is merely of an illustrative, but in no way limited nature. It is intended to cover all alternatives, modifications and equivalents of the various features and exemplary embodiments. Many other examples will be immediately and directly clear to the person skilled in the art in the light of the above description.

The exemplary embodiments have been selected and described in order to illustrate the principles underlying the invention and its possible practical applications in the best possible way. Thus, persons skilled in the art can optimally modify and use the invention and its various exemplary embodiments in relation to the intended use. In the claims as well as in the description, the terms “containing” and “having” are used as neutral terms for the corresponding term “comprising”. Furthermore, the use of the terms “one”, “a” and “an” is not intended in principle to exclude a plurality of features and components described in this way.

Claimed is:

1. A computer-implemented method for anonymized communication in a ring topology network, the computer-implemented method comprising the following steps:
receiving, by an active network node of a plurality of network nodes, a message array which has a plurality of disjoint message windows, each uniquely assigned to one of the plurality of network nodes, from a predecessor node in the ring topology network, wherein the plurality of disjoint message windows contain encrypted messages to a respective assigned network node as a group operation combination chain of keys and message contents belonging to a finite Abelian group;
obtaining, by the active network node, a temporary key assigned to the predecessor node;
decrypting a message directed to the active network node by combining the message array with an inverse element of the temporary key assigned to the predecessor node and with a temporary key stored in a local key memory, via a group operation of the finite Abelian group;
resetting, by the active network node, a decrypted message content in an assigned message window to a null element of the finite Abelian group to provide a reset message window;
creating a new temporary key and overwriting the temporary key with the new temporary key;
encrypting, by the active network node, the message array with the reset message window by combining the message array with the new temporary key via the group operation of the finite Abelian group to provide an encrypted message array; and
sending, by the active network node, the encrypted message array to a successor node in the ring topology network.

2. The computer-implemented method according to claim 1, wherein the creating the new temporary key comprises a random selection, by the active network node, of an element of the finite Abelian group as the new temporary key.

3. The computer-implemented method according to claim 2, further comprising the step:
sending, by the active network node, the new temporary key to the successor node in the ring topology network.

4. The computer-implemented method according to claim 3, wherein the sending of the new temporary key is carried out via a secured communication channel outside the ring topology network.

5. The computer-implemented method according to claim 1, wherein the active network node, before encrypting the message array, combines a message content directed to another of the plurality of network nodes with an encrypted content of a disjoint message window assigned to other network nodes plurality of network nodes via the group operation of the finite Abelian group.

6. A computer-implemented method for anonymized communication in a ring topology network, the computer-implemented method comprising the following steps:
receiving, by an active network node from a plurality of network nodes, a message array which has a plurality of disjoint message windows, each uniquely assigned to one of the plurality of network nodes, from a predecessor node in the ring topology network, wherein the plurality of disjoint message windows contain encrypted messages to a respective assigned network node as a group operation combination chain of keys and message contents belonging to a finite Abelian group;
obtaining, by the active network node, a temporary key randomly selected by the predecessor node;
randomly selecting, by the active network node, a new temporary key and overwriting a local key memory with the new temporary key;
adding, by the active network node, a message content directed to another of the plurality of network nodes by combining an encrypted content of a disjoint message windows assigned to the other of the plurality of network nodes via the group operation of the finite Abelian group;
encrypting, by the active network node, the message array by combining the message array with the new temporary key via the group operation of the finite Abelian group to provide an encrypted message array; and
sending, by the active network node, the encrypted message array and the new temporary key to a successor node in the ring topology network.

7. The computer-implemented method according to claim 6, wherein all method steps are iterated until the message array has completely traversed the ring topology network once.

8. The computer-implemented method according to claim 7, further comprising a step, carried out after all iterations of the method steps:
broadcasting the encrypted message array to all network nodes of the plurality of network nodes.

9. The computer-implemented method according to claim 8, further comprising the step:
decrypting messages directed to a respective network node by combining the message array with a temporary key stored in a local key memory of the respective network node via the group operation of the finite Abelian group.

10. A communication system comprising:
a plurality of network nodes which are actively communicatively connected in a ring topology,
wherein the plurality of network nodes are collectively configured to perform the method according to claim 1.

11. A communication system comprising:
a plurality of network nodes which are actively communicatively connected in a ring topology,
wherein the plurality of network nodes are collectively configured to perform the method according to claim 6.
